(19) United States
(12) Patent Application Publication
(10) Pub. No.: US 2009/0159016 A1
(43) Pub. Date: Jun. 25, 2009

(54) Animal Collar Slipcover System

(76) Inventors: Rebecca Marie Lang, Copley, OH (US); Mark Andrew Lang, Copley, OH (US)

Correspondence Address: BUCKINGHAM, DOOLITTLE & BURROUGHS, LLP, 3800 EMBASSY PARKWAY, SUITE 300, AKRON, OH, 44333-8332, US

(21) Appl. No.: 12/340,075

(22) Filed: Dec. 19, 2008

Related U.S. Application Data
(60) Provisional application No. 61/014,845, filed on Dec. 19, 2007.

(51) Int. Cl. A01K 27/00

(52) U.S. Cl. 119/863

(57) ABSTRACT

A slipcover system having a slipcover having a tubular cross-sectional orifice area that is substantially uniform for the longitudinal length of the slipcover; the slipcover being adapted to be fitted over the surface area, and for substantially the entire longitudinal length, of a collar to be used in combination with the slipcover; the slipcover having a longitudinal length that is substantially equal to the longitudinal length of the collar; the slipcover having a substantially closed-loop tubular shape; a decorative slipcover having at least one collar guide that is adapted to be fitted over a longitudinal length of the collar; the collar guide being removably attached to the decorative slipcover by a fastener selected from the group consisting of hook-and-loop faster, adhesive, and buttons; and an alternative collar slipcover that is directly and removably attached to the slipcover by a fastener selected from the group consisting of hook-and-loop faster, adhesive, and buttons.

### CROSS-REFERENCE TO RELATED APPLICATIONS

This patent application claims priority to provisional patent application Ser. No. 61/014845 filed on Dec. 19, 2007. The subject matter of the provisional patent application Ser. No. 61/014845 filed on Dec. 19, 2007 is hereby incorporated into this application by reference.

### BACKGROUND OF THE INVENTION

Animal collars are well-known, and there remains a need in the art for animal-collar systems that add additional utility and aesthetic appeal to what is known in the art.

### BRIEF SUMMARY OF THE INVENTION

A slipcover system having a slipcover having a tubular cross-sectional orifice area that is substantially uniform for the longitudinal length of the slipcover; the slipcover being adapted to be fitted over the surface area, and for substantially the entire longitudinal length, of a collar to be used in combination with the slipcover; the slipcover having a longitudinal length that is substantially equal to the longitudinal length of the collar; the slipcover having a substantially closed-loop tubular shape; a decorative slipcover having at least one collar guide that is adapted to be fitted over a longitudinal length of the collar; the collar guide being removably attached to the decorative slipcover by a fastener selected from the group consisting of hook-and-loop faster, adhesive, and buttons; and an alternative collar slipcover that is directly and removably attached to the slipcover by a fastener selected from the group consisting of hook-and-loop faster, adhesive, and buttons.

A slipcover system comprising a slipcover having a tubular cross-sectional orifice area that is substantially uniform for the longitudinal length of the slipcover; the slipcover being adapted to be fitted over the surface area, and for substantially the entire longitudinal length, of a collar to be used in combination with the slipcover; the slipcover having a longitudinal length that is substantially equal to the longitudinal length of the collar; the slipcover having a substantially closed-loop tubular shape; a decorative slipcover having at least one collar guide that is adapted to be fitted over a longitudinal length of the collar; the collar guide being fixably attached to the decorative slipcover; and an alternative collar slipcover that is directly and fixably attached to the slipcover.

A slipcover system comprising a slipcover having a tubular cross-sectional orifice area that is substantially uniform for the longitudinal length of the slipcover; the slipcover being adapted to be fitted over the surface area, and for substantially the entire longitudinal length, of a collar to be used in combination with the slipcover; the slipcover having a longitudinal length that is capable of covering substantially the longitudinal length of the collar; the slipcover having a substantially closed-loop tubular shape; a decorative slipcover having at least one collar guide that is adapted to be fitted over a longitudinal length of the collar; and the collar guide being attached to the decorative slipcover.

As a result of the slipcover system embodiments being easily discernible from distances, particular embodiments assist in quickly identifying animals from various distances.

Slipcover system embodiments provide signage or visual indicators that are helpful in natural disasters when animals may have numerous handlers. The visual indicators can list the address or location where an animal was found, the condition of the animal, injured, aggressive, and this quick identification and description would help protect both the handler and the animal.

Embodiments provide aesthetically pleasing visual elements.

### BRIEF DESCRIPTION OF THE SEVERAL VIEWS OF THE DRAWING

FIG. 1 is a perspective view of slipcover system 10 in use on a dog.

FIG. 2 is a perspective view of an embodiment of slipcover system 10.

FIG. 3 is an exploded perspective view of slipcover system 10.

FIG. 4 is a perspective view of an embodiment of slipcover system 10.

FIG. 5 is a front view of an embodiment of slipcover system 10.

FIG. 6 is a front view of an embodiment of slipcover system 10.

FIG. 7 is a front view of an embodiment of slipcover system 10.

FIG. 8 is a front view of an embodiment of slipcover system 10.

FIG. 9 is a front view of an embodiment of slipcover system 10.

FIG. 10 is a perspective view of an embodiment of slipcover system 10 in use on a dog.

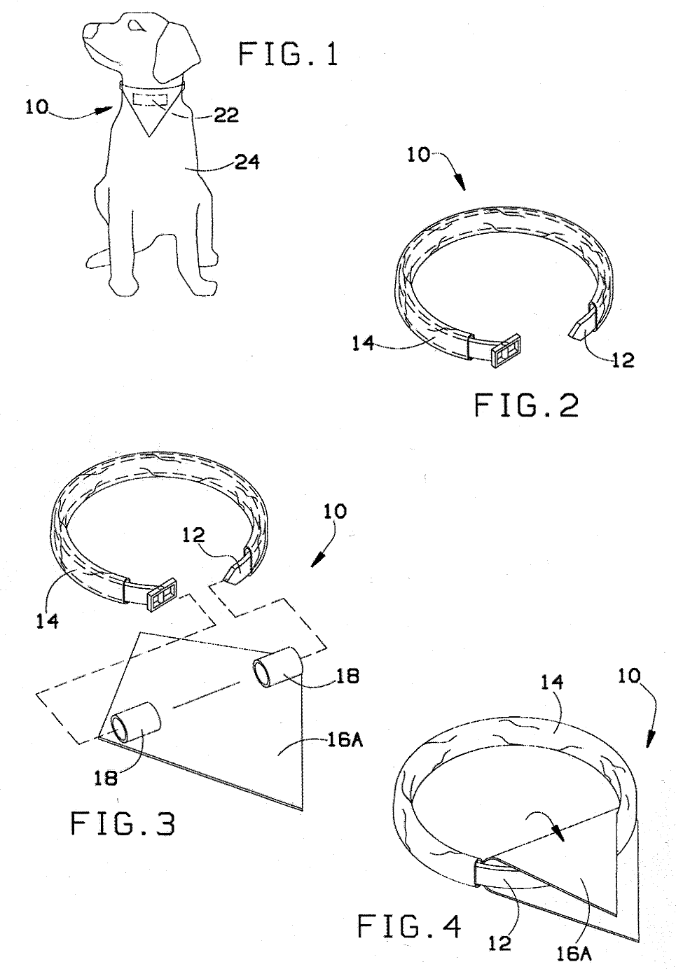

### DETAILED DESCRIPTION OF THE INVENTION

With reference to the figures, generally provided are embodiments directed to a slipcover system 10 that can be used in order to provide an aesthetic element, useful element, or both to animal collars. Slipcover system 10 embodiments may have collar 12, slipcover 14, decorative slipcover 16, alternative collar slipcover 20, collar guide 18, identification or signage 22, or any combination thereof.

An embodiment provides for slipcover 14 being substantially tubular and having characteristic dimensions that allow it to slip over collar 12 and substantially sheath, encase, or envelop a longitudinal length or section of collar 12. To ensure a substantially snug fit between collar 12 and slipcover 14, embodiments provide for slipcover 14 having a tubular cross-sectional orifice area that is substantially equal to the cross-sectional area of collar 12. For clarity, the tubular cross-sectional orifice area of slipcover 14 can be understood as the planar area that is substantially perpendicular or normal to the longitudinal direction of slipcover 14. Furthermore, the cross-sectional area of collar 12 can be understood as the planar area that is substantially perpendicular or normal to the longitudinal direction of collar 12.

Additional embodiments provide for slipcover 14 having a tubular cross-sectional orifice area that is greater than the cross-sectional area of collar 12 by about 1, 2, 3, 4 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100% of the cross-sectional area of collar 12. Also taught by this specification are all possible ranges of the immediately above percentages; this includes ranges having upper and lower limits defined by any combination of two of the above percentages. Still more embodiments provide for slipcover 14 having a tubular cross-sectional orifice area that is greater than the cross-sectional area of collar 12 by greater than 100%.

Embodiments provide for slipcover 14 having a tubular cross-sectional orifice area that is substantially uniform for its entire longitudinal length. Other embodiments provide for slipcover 14 having a tubular cross-sectional orifice area that is substantially non-uniform for its entire longitudinal length.

In a nonlimiting embodiment, the width of the material used to manufacture slipcover 14 can be determined by measuring the circumference of collar 12 to be used in combination with slipcover 14 and adding approximately 1″ to the circumference of collar 12. This extra inch of material can then be used during manufacture to secure a first edge of a substantially rectangular fabric to the opposite edge of the fabric and thereby create a substantially closed loop tubular configuration. Persons of ordinary skill in the art will be able to effectively attach the first edge of a substantially rectangular fabric to the opposite edge of the fabric using any means known in the art.

As a nonlimiting example, useful widths or characteristic dimensions of material used to manufacture slipcover 14 include 1, 2, 3, 4 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 millimeters. Also taught by this specification are all possible ranges of the immediately above lengths; this includes ranges having upper and lower limits defined by any combination of two of the above lengths.

Persons of ordinary skill in the art will be able to determine the dimensions or width of materials useful for manufacturing slipcover 14 by assessing the end-use degree of snugness between slipcover 14 and collar 12 without having to exercise undue experimentation. As will be understood by persons of ordinary skill in the art, the characteristic dimensions of material or materials used to manufacture slipcover 14 will affect the finished tubular cross-sectional orifice area of slipcover 14 as described above.

The characteristic dimensions of slipcover 14 affect the snugness or relatively close fit to collar 12. In embodiments, slipcover 14 stays in substantially the same position with respect to collar 12 while in use due to the close fit of slipcover 14 to collar 12.

Embodiments provide for slipcover 14 having a longitudinal length that is substantially equal to the longitudinal length of collar 12. Additional embodiments provide for slipcover 14 having a longitudinal length that is at least, equal to, or up to 80, 81, 82, 83, 84, 85, 86, 87, 88, 89, 90, 91, 92, 93, 94, 95, 96, 97, 98, 99, 100, 101, 102, 103, 104, 105, 106, 107, 190, 109, 110, 111, 112, 113, 114, 115, 116, 117, 118, 119 or 120% of the longitudinal length of collar 12. Also taught by this specification are all possible ranges of the immediately above percentages; this includes ranges having upper and lower limits defined by any combination of two of the above percentages. After examining collar 12, persons of ordinary skill in the art will be able to identify useful slipcover 14 longitudinal lengths without having to exercise undue experimentation.

In embodiments, additional material may be included to close the hem if needed, to provide scrunching as desired, or to fit various lengths of standard collars with a substantially universal slipcover 14 longitudinal length. As a nonlimiting example, useful longitudinal lengths for slipcover 14 include 1, 2, 3, 4 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 inches. Also taught by this specification are all possible ranges of the immediately above lengths; this includes ranges having upper and lower limits defined by any combination of two of the above lengths.

Embodiments provide for the longitudinal length of the slipcover 14 being achieved by measuring collar 12 from the tip of the tongue to the near side of the buckle or closure. Embodiments provide for the longitudinal length of slipcover 14 being substantially equal to the longitudinal length of collar 12.

In embodiments, slipcover 14 when in use with collar 12 does not cover the buckle or closure of collar 12, the portion of the tongue that is inserted into the buckle, or the identification tags such as a dog license. This permits easy access to install or remove collar 12, install or remove slipcover 14, alternative collar slipcover 20, and/or decorative slipcover 16, walk the animal, and identify the animal.

Embodiments provide for slipcover 14, decorative slipcover 16, or alternative collar slipcover 20 being manufactured from material that is sufficiently flexible to accommodate the bending and curvature of slipcover system 10 while sheathed over collar 12 that is clasped around the neck of an animal.

In embodiments, materials useful for manufacturing slipcover 14, decorative slipcover 16, or alternative collar slipcover 20 include fabrics, satin, silk, nylon, polyester, cotton, cotton polyester blend, washable cotton, washable cotton polyester blend, hemp, paper, leather, plastic, rubber, metal, metal combinations, washable, non-washable, dry-cleanable, non-flammable, fire retardant, flexible, non-flexible, starch, fusible web, backing, materials known to persons of ordinary skill in the art, and combinations thereof.

Embodiments provide for using layers of materials to manufacture slipcover 14, decorative slipcover 16, or alternative collar slipcover 20. Layers of materials can include any number of materials layered on top of and in contact with an adjacent layer or layers. Embodiments provide for one or more layers positioned or sandwiched between top and bottom layers. Embodiments provide for the one or more layers that are positioned or sandwiched between top and bottom layers to be manufactured from starch, fusible web, backing, or materials known to persons of ordinary skill in the art, and combinations thereof. Other embodiments provide for the one or more layers that are positioned or sandwiched between top and bottom layers to be manufactured from a material that is more rigid than the material used to manufacture the top or bottom layer.

Slipcover 14, decorative slipcover 16, or alternative collar slipcover 20 may be manufactured by including the use of starch, fusible web, backing, or materials known to persons of ordinary skill in the art, and combinations thereof in combination with and optionally permanently adhered to two pieces of fabric by using a hot surface, conventional iron, or other means. Persons of ordinary skill in the art will be able to effectively attach the fusible web, backing, or other materials using any means known in the art.

Slipcover 14, decorative slipcover 16, or alternative collar slipcover 20 may be comprised of fabrics such as satin, silk, nylon, polyester, cotton or cotton polyester blend. The material may also consist of hemp, leather, paper, plastic, rubber, wood, wood by products and/or combinations, metal or metal combinations, washable, dry-cleanable, non-washable, non-flammable, fire-retardant materials and/or any combination flexible or non-flexible materials. An embodiment provides for manufacture using washable cotton or cotton polyester blend.

Embodiments use conventional stitching, hems, seems, or combinations thereof to create the generally tubular structure of slipcover 14 by fixedly attaching a first edge of a generally rectangular piece of material to the opposite edge. Embodiments provide for hems and/or seems to be closed by using methods known in the art.

Slipcover 14, decorative slipcover 16, or alternative collar slipcover 20 can be manufactured by cutting or forming one or more pieces of fabric or material into the desired shape and size. In those embodiments having two pieces of fabric or material, the two pieces can be attached to create a reversible effect. The two pieces of material may be attached by stitching such as by hand or sewing machine using needle and thread or like material, applying adhesive such as glue, gluing or stitching on hook-and-loop fasteners, stitching on elastic, stitching or gluing on shoe lace, gluing, stitching, or lacing wire, applying rivets using manufacturer standards, stitching on eyelets, gluing on Ziploc, stitching on zippers, stitching or glue on snaps and/or buttons or other materials. Other methods and materials known in the art may be used. A method is to sew by machine or by hand the two pieces of material together along the seam or hem using needle and thread with a sewing machine.

Embodiments use conventional stitching, hems, seems, or combinations thereof to attach a first element of slipcover system 10 to a second element of slipcover system 10. Non-limiting examples include attaching slipcover 14 to decorative slipcover 16 using conventional stitching, hems, seems, or combinations thereof. Another non-limiting example includes attaching slipcover 14 to alternative collar slipcover 20 using conventional stitching, hems, seams, or combinations thereof.

Backing and/or fusible web, and other like materials may be attached to the backside of non-reversible slipcovers, alternative slipcovers 20, and decorative slipcovers 16 and between the layers of the reversible slipcovers alternative slipcovers 20, and decorative slipcovers 16, by using manufacturer specifications or other methods known in the art.

Non-reversible items may consist of one piece of material or a layer of material with/or without seams or hems and with or without ornamentation.

Slipcover 14, decorative slipcover 16, or alternative collar slipcover 20 may be reversible or nonreversible and manufactured using one or more materials. Embodiments provide for slipcover 14 being manufactured from two materials. Additional embodiments provide for slipcover 14 being manufactured from three materials. Still other embodiments provide for slipcover 14 being manufactured from four or more materials.

Slipcover 14, decorative slipcover 16, or alternative collar slipcover 20 may be manufactured to be reversible by layering two materials on top of one another and fixedly attaching them together such that the surfaces of the slipcover 14, decorative slipcover 16, or alternative collar slipcover 20 may be flipped or reversed as is conventionally understood in the art.

If needed, seams or hems may used to finish edges and/or hold two pieces of material together that may create a reversible effect. Seams or hems may be secured using stitching such as by hand or sewing machine with needle and thread, or like materials; adhesive such as glue, Velcro, hook-and-loop fasteners, elastic, shoe lace or other strings, yarns etc., wire, rivets, eyelets, Ziploc, zippers, snaps, clips, buckles, hooks and eyes, pins, rings, fasteners, tape and/or buttons or any combination. Any of the above mentioned fasteners may be attached using adhesive, stitching by needle and thread by machine or hand, rivet gun, hammer, and/or by other methods and/or manufacturer specifications. A method to close the hem or seam is stitching using needle, thread and sewing machine.

In nonlimiting embodiments, decorative slipcover 16 is a layer of material or materials that is fixably or removably attached to collar 12, slipcover 14, or both by using at least one collar guide 18. Embodiments provide for decorative slipcover 16 having two collar guides 18 that are removably or fixably attached thereto.

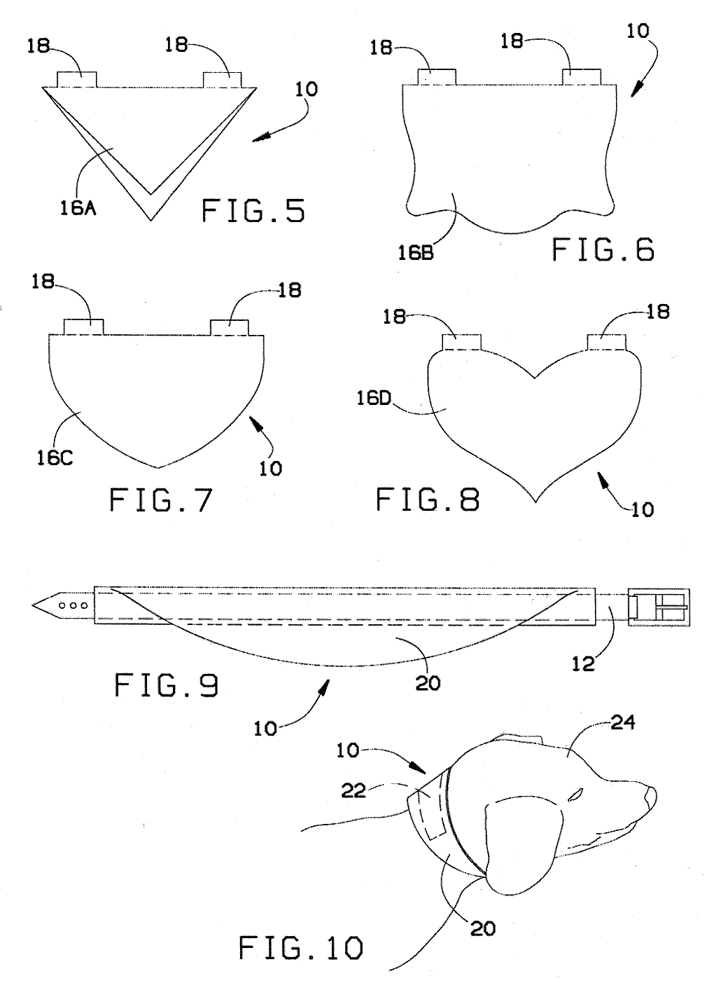

Decorative slipcover 16 can have any shape or size, and there are no limitations directed to useful shapes or sizes. Nonlimiting examples of shapes of decorative slipcover 16 include shapes illustrated in FIGS. 5-8. Additional nonlimiting examples of useful shapes include triangular, substantially triangular, square, substantially square, heart-shaped, substantially heart-shaped, circular, substantially circular, semicircular, substantially semicircular, rectangular, substantially rectangular, non-triangular, substantially non-triangular, non-square, substantially non-square, non-heart-shaped, substantially non-heart-shaped, non-circular, substantially non-circular, non-semicircular, substantially non-semicircular, non-rectangular, and substantially non-rectangular.

Decorative slipcover 16 may be reversible or nonreversible and manufactured using one or more material layers. Embodiments provide for decorative slipcover 16 being manufactured from one, two, three, or four or more material layers.

Embodiments provide for decorative slipcover 16 being fixably or removably attached to collar 12, slipcover 14, or both by using one, two, or three collar guides 18.

Decorative slipcover 16 and alternative collar slipcover 20 may be permanently or non-permanently attached to collar 12, slipcover 14, or both using collar guides 18, or other fasteners such as but not limited to: Velcro, hook-and-loop fasteners, elastic, shoe lace or other strings, yarns etc., wire, rivets, eyelets, Ziploc, zippers, snaps, clips, buckles, hooks and eyes, pins, rings, fasteners, tape and/or buttons or any combination, sewing or stitching, or my other means know in the art and or/manufacturer specifications. Collar guide 18 or any of the above mentioned fasteners may be attached using adhesive, stitching by needle and thread by machine or hand, rivet gun, hammer, and/or by other methods and/or manufacturer specifications. A method of permanent attachment is stitching using needle, thread and sewing machine and sewing slipcover 14 to decorative or alternative slipcover 16, 20. The two pieces should be parallel and attached in a manner as to give the appearance that they are one slipcover 14 or alternative collar slipcover 20 that is either reversible or non-reversible. An embodiment for non-permanent attachment of decorative slipcover 16 two collar 12, slipcover 14 or both is the use of collar guides 18.

Embodiments provide for decorative slipcover 16 being used independent of slipcover 14.

In nonlimiting embodiments, alternative collar slipcover 20 is removably or fixedly attached directly to slipcover 14 with or without the use of one or more collar guides 18.

Alternative collar slipcover 20 can have any shape, and there are no limitations directed to useful shapes. Nonlimiting examples of shapes of alternative collar slipcover 20 include shapes illustrated in FIGS. 5-8. Additional nonlimiting examples of useful shapes include triangular, substantially triangular, square, substantially square, heart-shaped, substantially heart-shaped, circular, substantially circular, semicircular, substantially semicircular, rectangular, substantially rectangular, non-triangular, substantially non-triangular, non-square, substantially non-square, non-heart-shaped, substantially non-heart-shaped, non-circular, substantially non-circular, non-semicircular, substantially non-semicircular, non-rectangular, and substantially non-rectangular.

Alternative collar slipcover 20 may be reversible or nonreversible and manufactured using one or more material or one or more layers of materials. Embodiments provide for alternative collar slipcover 20 being manufactured from two, three, four, or five materials or layers of materials.

Embodiments provide for alternative collar slipcover 20 being fixedly or removably attached to slipcover 14. To fixably or removably attach alternative collar slipcover 20 to slipcover 14, fasteners may be used such as but not limited to: Velcro, hook-and-loop fasteners, elastic, shoe lace or other strings, yarns etc., wire, rivets, eyelets, Ziploc, zippers, snaps, clips, buckles, hooks and eyes, pins, rings, fasteners, tape and/or buttons or any combination. Alternative collar slipcover 20 may be attached using adhesive, stitching by needle and thread by machine or hand, rivet gun, hammer, and/or by other methods and/or manufacturer specifications. A method of permanent attachment is stitching using needle, thread and sewing machine and sewing slipcover 14 to alternative collar slipcover 20. An additional embodiment is directed to using collar guides 18 to attach collar slipcover 20 to slipcover 14.

An embodiment for non-permanent attachment of alternative slipcover 20 to slipcover 14 is to use snaps that may be located anywhere along the two pieces but especially near the section of slipcover 20 that will be relatively positioned near the buckle or collar closure at the front of the animals neck and/or at the back of the animal's neck. Additional snaps may be needed to accommodate various sizes of animals. The snaps would be placed in a parallel fashion with the male piece being on the slipcover and the female piece being attached on the alternative slipcover. One method of attaching the snaps is with an adhesive or with needle and thread such as by hand or sewing machine.

Embodiments provide for collar guide 18 being a closed loop or substantially closed loop that is removably or fixably attached to decorative slipcover 16 or alternative collar slipcover 20. Embodiments provide for collar guide 18 being removably or fixedly attached to decorative slipcover 16.

Embodiments provide for collar guide 18 being substantially circular in shape. Other shapes may be used as determined by persons of ordinary skill in the art.

Collar guide 18 may be comprised of fabrics such as satin, silk, nylon, polyester, cotton or cotton polyester blend. The collar-guide material may also consist of hemp, leather, paper, plastic, rubber, wood, wood by products and/or combinations, metal or metal combinations, washable, dry-cleanable, non-washable, non-flammable, fire-retardant materials and/or any combination of flexible or nonflexible materials. An embodiment provides for collar guide 18 being manufactured from a washable cotton or cotton polyester blend that may be ribbon.

Embodiments provide for collar guide 18 being manufactured to be long enough to create a loop that is large enough to insert collar 12 with or without the additional slipcover 14 therein.

Collar guide 18 may be removably or fixably attached to decorative slipcover 16 or alternative collar slipcover 20 on any respective surface of decorative slipcover 16 or alternative collar slipcover 20. Nonlimiting embodiments provide for one, two, three or more collar guides 18 being removably or fixably attached substantially at the perimeter edge of decorative slipcover 16 or alternative collar slipcover 20.

Collar guide 18 may be removably or fixably attached to decorative slipcover 16 or alternative collar slipcover 20 by stitching such as by hand or sewing machine using needle and thread or using fasteners such as but not limited to adhesive such as glue, Velcro, hook-and-loop fasteners, elastic, shoe lace or other strings, yarns etc., wire, rivets, eyelets, Ziploc, zippers, snaps, clips, buckles, hooks and eyes, pins, rings, fasteners, tape and/or buttons or any combination.

In an embodiment, the method of attaching collar guides 18 to the reversible decorative slipcover 16 is to create a hole such as a buttonhole approximately ¼″ inch in from the side of decorative slipcover 16 at the fold as show in FIG. 3, item 18. This hole allows the collar guide to pass from one side of the reversible decorative slipcover 16 to the other side. It is preferred that collar guide 18 be secured to the first or second side of decorative slipcover 16 or between the two layers of material of decorative slipcover 16 using needle, thread and sewing machine, but other fasteners or methods may be used. The unattached end of the loop may have one side of a fastener attached consisting of Velcro, hook-and-loop fasteners, elastic, shoe lace or other strings, yarns etc., wire, rivets, eyelets, Ziploc, zippers, snaps, clips, buckles, hooks and eyes, pins, rings, fasteners, tape and/or buttons or any combination with the other side of the fastener attached to the decorative slipcover as necessary to secure the end of collar guide 18 and close the loop around the animal collar. One method is to attach Velcro, hook-and-loop fasteners, and/or snaps to collar guide 18 and to decorative slipcover 16 by sewing with needle and thread or by applying fabric glue.

In another embodiment, collar guide 18 is attached to alternative collar slipcover 20 or decorative slipcover 16 by placing one end of a collar-guide ribbon between any layers of alternative-color-slipcover or decorative-slipcover fabric and stitch along the seam using needle, thread, and sewing machine. In another embodiment, collar guide 18 is fixedly attached to alternative collar slipcover 20 or decorative slipcover 16 using conventional methods associated with needle, thread and sewing machine. Other methods known in the art may be used.

Signage 22 may be in the form of numbers, letters, embroidery, imprints, iron-on, lace, ribbon, badges, patches, logos, graphics, art, buttons, pins, jewels, and/or reflectors and/or reflective materials, metals, medals, or other materials or combination of materials. Examples include but are not limited to scout badges, police badges, police units, and embroidered company logos.

Slipcover system 10, collar 12, slipcover 14, decorative slipcover 16, collar guide 18, or alternative collar slipcover 20 may be pre-printed with vital, quickly discernable descriptions such as SICK, INJURED, or AGGRESSIVE for immediate use during emergencies. Any string of characters or shapes may be used as signage 22.

Additional embodiments use blank writing space for signage 22 that allows handlers to quickly write pertinent information on the slipcover, alternative collar slipcover, or decorative slipcover using a common permanent marker.

Signage 22 may be comprised of fabrics such as satin, silk, nylon, polyester, cotton or cotton polyester blend. The material may also consist of hemp, leather, paper, plastic, rubber, metal or metal combinations, wood, wood by-products and or combinations, washable, dry-cleanable, non-washable, non-flammable, fire-retardant materials and/or any combination of flexible or non-flexible materials. The preferred material is a washable cotton or cotton polyester blend. Other items such as, but not limited to, lace or ribbon may be used throughout, but especially along seams. Reflectors and/or reflective material may be used to help with night visibility.

Signage 22 may be removably or fixably attached to slipcover system 10. An embodiment of attachment is sewing by stitching with needle and thread by hand or machine, but signage may also be attached using adhesive such as glue, Velcro, elastic, shoe lace or other strings, yarns etc., wire, rivets, eyelets, Ziploc, zippers, snaps, clips, buckles, hooks and eyes, pins, rings, fasteners, tape and/or buttons or any combination or other means known in the art.

Signage 22 may be placed to be visible from the back, while in use on an animal, as shown in FIG. 10. Other embodiments include placing signage 22 in any position on decorative slipcover 16 or alternative collar slipcover 20. In an embodiment, placement of signage is any location that will be highly visible as determined by persons of ordinary skill in the art.

Embodiments provide for signage 22 being on slipcover 14, alternative collar slipcover 20, and decorative slipcover 16. Additional embodiments provide for signage 22 being on all sides of slipcover 14, alternative collar slipcover 20, and decorative slipcover 16.

There are many uses for slipcover system 10. Many animals such as working dogs may not have a handler present at all time. Therefore it is vitally important for the public to easily recognize the nature of animal's use and actions. Examples would include, but not limit to, police canine units, Seeing Eye dogs, bomb or drug detection canine units, as well as search and rescue canine units. Since a handler may not be present, alternative and decorative slipcover 20, 16 embodiments are designed to be removable by animal movement if the alternative slipcover 20 or decorative slipcover 16 becomes caught on an object. Embodiments provide for slipcover 14 remaining on the subject collar if decorative slipcover 16, alternative collar slipcover 20, or both are detached from slipcover 14 during use.

Other identification uses include identification of farm animals such as but not limited to cattle, Alpacas, goats, or sheep if branding or ear tags are not desired. Breeders may also use the slipcover system 10 to identify animal offspring. Veterinarians and veterinarian hospitals may use slipcover system 10 to help identify animals much like an arm bracelet on a hospital patient. Slipcover system 10 may be very useful during natural catastrophes when many animals are rescued. It could also be used to identify sick, injured or aggressive animals as well as identifying that an animal is part of the canine unit. It could be used by any working animal and could be made of a fire-retardant fabric.

An alternative use of slipcover system 10 is for decoration or aesthetic purposes. In embodiments, slipcover system 10, alternative collar slipcover 20, and decorative slipcover 16 may be used together or independently for animal adornment.

While the present invention has been described in terms of specific embodiments, it is to be understood that the invention is not limited to these disclosed embodiments. This invention may be embodied in many different forms and should not be construed as limited to the embodiments set forth herein; rather, these embodiments are provided by way of illustration only.

What is claimed is:

1. A slipcover system comprising:
a slipcover having a tubular cross-sectional orifice area that is substantially uniform for the longitudinal length of the slipcover;
the slipcover being adapted to be fitted over the surface area, and for substantially the entire longitudinal length, of a collar to be used in combination with the slipcover;
the slipcover having a longitudinal length that is substantially equal to the longitudinal length of the collar;
the slipcover having a substantially closed-loop tubular shape;
a decorative slipcover having at least one collar guide that is adapted to be fitted over a longitudinal length of the collar;
the collar guide being removably attached to the decorative slipcover by a fastener selected from the group consisting of hook-and-loop faster, adhesive, and buttons; and
an alternative collar slipcover that is directly and removably attached to the slipcover by a fastener selected from the group consisting of hook-and-loop faster, adhesive, and buttons.

2. The slipcover system of claim 1, further comprising signage on the slipcover, decorative slipcover, collar guide, or alternative collar slipcover;
the signage being made up at least in part by English letters.

3. The slipcover system of claim 1, wherein the decorative slipcover has two collar guides.

4. The slipcover system of claim 1, further comprising a collar.

5. A slipcover system comprising:
a slipcover having a tubular cross-sectional orifice area that is substantially uniform for the longitudinal length of the slipcover;
the slipcover being adapted to be fitted over the surface area, and for substantially the entire longitudinal length, of a collar to be used in combination with the slipcover;
the slipcover having a longitudinal length that is substantially equal to the longitudinal length of the collar;
the slipcover having a substantially closed-loop tubular shape;
a decorative slipcover having at least one collar guide that is adapted to be fitted over a longitudinal length of the collar;
the collar guide being fixably attached to the decorative slipcover; and
an alternative collar slipcover that is directly and fixably attached to the slipcover.

6. The slipcover system of claim 5, further comprising signage on the slipcover, decorative slipcover, collar guide, or alternative collar slipcover;
the signage being made up at least in part by English letters.

7. The slipcover system of claim 5, wherein the decorative slipcover has two collar guides.

8. The slipcover system of claim 5, further comprising a collar.

9. The slipcover system of claim 5, wherein the collar guide is fixably attached to the decorative slipcover by sewing or glue, and the alternative collar slipcover is directly and fixably attached to the slipcover by sewing or glue.

10. A slipcover system comprising:
a slipcover having a tubular cross-sectional orifice area that is substantially uniform for the longitudinal length of the slipcover;
the slipcover being adapted to be fitted over the surface area, and for substantially the entire longitudinal length, of a collar to be used in combination with the slipcover;
the slipcover having a longitudinal length that is capable of covering substantially the longitudinal length of the collar;
the slipcover having a substantially closed-loop tubular shape;
a decorative slipcover having at least one collar guide that is adapted to be fitted over a longitudinal length of the collar; and
the collar guide being attached to the decorative slipcover.

11. The slipcover system of claim 10, further comprising an alternative collar slipcover is attached to the slipcover.

12. The slipcover system of claim 10, further comprising signage on the slipcover, decorative slipcover, collar guide, or alternative collar slipcover;
the signage being made up at least in part by English letters.

13. The slipcover system of claim 10, wherein the decorative slipcover has two collar guides.

14. The slipcover system of claim 10, further comprising a collar.

15. The slipcover system of claim 10, wherein the at least one collar guide is removably attached to the decorative slipcover.
